(19) United States
(12) Patent Application Publication
(10) Pub. No.: US 2015/0101979 A1
(43) Pub. Date: Apr. 16, 2015

(54) STABILIZED NANOFIBERS, METHODS FOR PRODUCING, AND APPLICATIONS THEREOF

(71) Applicant: CORNELL UNIVERSITY, Ithaca, NY (US)

(72) Inventors: Yong Lak Joo, Ithaca, NY (US); Daehwan Cho, Ithaca, NY (US); Kyoung Woo Kim, Ithaca, NY (US)

(21) Appl. No.: 14/391,542

(22) PCT Filed: Apr. 10, 2013
(86) PCT No.: PCT/US2013/035936

§ 371 Date: Oct. 9, 2014

Related U.S. Application Data
(60) Provisional application No. 61/622,164, filed on Apr. 10, 2012.

(51) Int. Cl. B01D 39/16; B01D 39/18; B29D 99/00

(52) U.S. Cl. CPC B01D 39/1615; B29D 99/0078; B01D 39/1623; B01D 39/18; B29K 2029/04
USPC 210/500.1; 525/61; 525/153; 524/26; 264/484; 425/174.8 E

(57) ABSTRACT

A surface treatment method is described herein where a stabilizing (e.g., crosslinking agent) is pre-mixed into a fluid stock comprising a processable polymer. The stock is processed to form products (e.g., nanofibers or films), followed by exposing the products to a stabilizing (e.g., crosslinking catalyst, such as acid vapors), which results in stabilization (e.g., polymer cross-linking on the surface of the product). In some embodiments, the morphology of the product is not changed upon crosslinking. Moreover in some instances, this method does not need strong acids and is performed with weak acids such as acetic acid which reduces environmental pollution. In addition to water soluble polymers (e.g., PVA), this method is applicable to proteins such as soy protein, and combinations of polymers and proteins in various embodiments.

### CROSS-REFERENCE

This application claims the benefit of U.S. Provisional Application No. 61/622,164, filed Apr. 10, 2012, which is incorporated herein by reference in its entirety.

### BACKGROUND OF THE INVENTION

Nanotechnology is the manipulation of matter at an atomic and molecular scale and is a diverse field involving many different structures, techniques and potential applications. Of them, one structure is a nanofiber, which generally has a diameter of less than a few microns and can be of various lengths. Without limitation, nanofibers are useful in various applications such as in high performance filters.

### SUMMARY OF THE INVENTION

In some instances, products (e.g., nanofibers or films) are made from soluble polymers (e.g., water soluble polymers such as PVA) or thermoplastics. Water soluble polymers are environmentally advantageous in some applications (e.g., avoids the use of organic solvents). Yet, the products made from water soluble polymers are also water soluble in some instances and are generally used in limited areas (i.e., non aqueous environments). There is a need for methods for producing water-resistant products comprising water-soluble polymers. In some instances, such products are resistant (i.e., resistant to degradation) to water present in the air (e.g., moisture).

In some instances, using glutaraldehyde as a cross-linker and a strong acid (e.g., HCl or H₂SO₄) as a catalyst makes the product water-resistant. In some embodiments, such methods adopt a wet method where water soluble polymer materials are soaked in cross-linking solution comprising glutaraldehyde, strong acid, and non-solvent. This method results in alterations to the morphology (e.g., swelling) of the product in some instances.

Another method is an in situ method where glutaraldehyde and strong acid are pre-mixed with polymer solutions and then processed into products. This method is simple, but the cross-linking reaction time is too short to process the solution into products (e.g., fibers with good control of spinability) in some embodiments. In some instances, this method results in poor quality control and difficulty in maintenance such as cleaning electrospinning nozzles (e.g., for large-scaling spinning processes).

Provided in certain embodiments herein is a surface treatment method where a crosslinking agent is pre-mixed into a solution comprising water-soluble polymer. In some embodiments, no catalyst is added to the pre-mixed solution comprising water-soluble polymer (e.g., cross-linking does not occur during the material-forming process). The resulting solution is then processed to form products (e.g., fibers or films), followed by exposing the products to a crosslinking catalyst (e.g., acid vapors), which results in cross-linking on the surface of the product. In some embodiments, the morphology of the product is not changed upon crosslinking, or changes in morphology of the product is changed to a lesser extent than would have been in a similar system using the soaking process described above. Moreover in some instances, this method does not need strong acids and is performed with weak acids such as organic or buffering acids, such as acetic acid or citric acid, which reduces environmental pollution. In addition to synthetic water soluble polymers (e.g., PVA), this method is applicable to natural polymers, such as proteins such as soy protein, and combinations of polymers and proteins in various embodiments.

In one aspect, described herein is a process for producing an insoluble or a low solubility polymer product (e.g., a water-resistant polymer film or a water-resistant polymer nanofiber), the process comprising: forming a polymer film or polymer nanofiber from a fluid stock, the fluid stock comprising a cross-linking agent and at least one polymer (e.g., that is water soluble); and exposing (e.g., the surface of) the polymer film or polymer nanofiber to a cross-linking catalyst, thereby producing the low solubility polymer product (e.g., water-resistant polymer film or the water-resistant polymer nanofiber). In specific embodiments, the insoluble or low solubility polymer product is insoluble or has low solubility in water, alcohol, organic solvent, or the like. In more specific embodiments, the insoluble or low solubility polymer product is insoluble or has low solubility in water. In some embodiments, a low solubility cross-linked polymer has a solubility less than 10% (e.g., less than 5%, less than 2%, or the like) of an otherwise identical non-cross-linked material (e.g., a material without the cross-linking agent or catalyst).

In some embodiments, forming the polymer film comprises spin coating, spraying, deposition, or any combination thereof of a fluid polymer stock. In some embodiments, forming the polymer nanofiber comprises electrospinning, electroblowing, centrifugal spinning, or any combination thereof of a fluid polymer stock. In some embodiments, a gas is co-axially electrospun with the fluid stock (i.e., the electrospinning is gas assisted).

In some embodiments, the fluid stock comprises polymer. In specific embodiments, the polymer is a water soluble polymer. In certain embodiments, the fluid stock further comprises a cross-linking agent (e.g., an agent that upon treatment with a cross-linking catalyst will from a covalent bond, such as inter- or intra-strand crosslinking when a nanofiber mat is the polymer product produced). In some embodiments, the fluid stock is aqueous. In some embodiments, the polymer is biodegradable. In some embodiments, the polymer not biodegradable.

In some embodiments, the polymer is protein, PVA, PVAc, PEO, PVP, or any combination thereof. In some embodiments, the polymer comprises protein. In some embodiments, the protein comprises soy protein isolate (SPI), soy protein concentrate, soy flour, or any combination thereof. In some embodiments, the protein does not comprise PVA. In some embodiments, the protein does not comprise both PVA and SPI. In some embodiments, the polymer is a water-soluble polymer. In other embodiments, the polymer is a water-insoluble polymer. In some embodiments, the polymer is a solvent-soluble polymer. In certain embodiments, the polymer is a thermoplastic. Generally, the polymer is capable of being electrospun or formed into a film. In some embodiments, the polymer is polyimide, nylon, polyaramide, polybenzimidazole, polyetherimide, polyacrylonitrile, polyethylene terphthalate (PET), polypropylene, polyethylene oxide (PEO), polyaniline, polyethylene naphthalate (PEN), polybutylene terephthalate (PBT), polystyrene, polyvinyl chloride (PVC), polyvinyl alcohol (PVA), polyvinylidene fluoride (PVDF), polyvinyl butylene, copolymers thereof, combinations thereof, or the like.

In certain embodiments, the cross-linking agent is an agent, with the addition of a cross-linking catalyst (such as acid), causes the polymer of a polymer product to cross-link. In some embodiments, the cross-linking agent is glutaraldehyde (GA), glyoxal, polyacetal, bis-β-hydroxyethyl sulfone, propylene glycol diglycidyl ether, 4,5-dihydroxy-1,3-dimethyleneurea and 4,5-dihydroxy-1,3-bis-(β-hydroxyethyl)ethyleneurea, dimethyl suberimidate, bissulfosuccinimidyl suberate (BS3), formaldehyde, carbodiimide, beeswax, hexamethylphosphoramide, or any combination thereof. In some embodiments, the cross-linking agent does not comprise glutaraldehyde (GA).

In some embodiments, the cross-linking agent comprises at most 1% of the fluid stock.

In some embodiments, cross-links are formed on the surface of the polymer film or the polymer nanofiber. In some embodiments, the cross-linked nanofiber further comprises non-crosslinked polymer away from the surface of the nanofiber. In some embodiments, intra-fiber cross-links are formed, inter-fiber cross-links are formed, or any combination thereof. In some embodiments, cross-links comprise covalent bonds, ionic bonds, or any combination thereof.

In some embodiments, the cross-linking catalyst comprises acid. In some embodiments, the acid is a weak acid. In some embodiments, the acid has a pKa greater than 1.0. In some embodiments, the catalyst comprises citric acid, acetic acid, hydrofluoric acid, nitric acid, formic acid, carbonic acid, phosphoric acid, sulfuric acid, oxalic acid, or any combination thereof. In some embodiments, the cross-linking catalyst comprises acid vapor. In some embodiments, the cross-linking catalyst comprises an acidic solution. In some embodiments, the concentration of the acid in the vapor is at most 5% (w/w).

In some embodiments, the nanofiber is treated with acid vapor for between about 1 minute and 10 minutes. In some embodiments, the nanofiber is treated with acid vapor for a time sufficient to achieve the desired amount of cross-linking.

In some embodiments, the size and/or shape of the nanofiber is substantially unchanged upon cross-linking (e.g., non-swollen). In some embodiments, the tensile strength of the nanofiber after cross-linking is at least the same as the tensile strength of the nanofiber before cross-linking. In some embodiments, the thermal degradation temperature of the nanofiber after cross-linking is at least as high as the thermal degradation temperature of the nanofiber before cross-linking.

In one aspect, described herein is a filter comprising fluid-resistant cross-linked polymer nanofibers, wherein the polymer is soluble in the fluid in the absence of cross-linking.

In some embodiments, the fluid is water. In some embodiments, the filter is biodegradable. In some embodiments, the surface of the nanofibers are cross-linked. In some embodiments, the filter further comprises fluid soluble polymer away from the surface of the nanofiber.

In one aspect, described herein is a filter incorporating the nanofiber produced by the process of any of the preceding claims. In one aspect, described herein is a filter incorporating the nanofiber of any of the claims.

In some embodiments, the filter is capable of removing at least 70% of 300 nm diameter particles from a fluid stream when the nanofiber coverage is 1.0 g/m². In certain embodiments, the filter is capable of removing at least 30%, at least 50%, at least 60%, at least 70%, at least 80%, or the like of 200 nm, 300 nm, 400 nm, and/or 500 nm diameter particles from a fluid stream when the nanofiber coverage is at most 0.5 g/m², at most at most 1.0 g/m², at most 2.0 g/m², at most 3.0 g/m², or the like.

In one aspect, described herein is a fluid-resistant nanofiber, wherein the nanofiber: comprises cross-linked polymer on the surface of the nanofiber, the cross-linked polymer being soluble in a fluid when not cross-linked; and is resistant to dissolution or swelling in the fluid.

In some embodiments, the fluid is water. In some embodiments, the nanofiber is non-swollen. In some embodiments, the nanofiber further comprises fluid soluble polymer away from the surface of the nanofiber.

In some embodiments, the polymer is biodegradable. In some embodiments, the polymer is not biodegradable. In some embodiments, the polymer is protein, PVA, PVAc, PEO, PVP, or any combination thereof. In some embodiments, the polymer comprises protein. In some embodiments, the protein comprises soy protein isolate (SPI). In some embodiments, the protein does not comprise PVA. In some embodiments, the protein does not comprise both PVA and SPI.

In some embodiments, the cross-links are formed by glutaraldehyde (GA), glyoxal, polyacetal, bis-β-hydroxyethyl sulfone, propylene glycol diglycidyl ether, 4,5-dihydroxy-1,3-dimethyleneurea and 4,5-dihydroxy-1,3-bis-(β-hydroxyethyl)ethyleneurea, dimethyl suberimidate, bissulfosuccinimidyl suberate (BS3), formaldehyde, carbodiimide, beeswax, hexamethylphosphoramide, or any combination thereof. In some embodiments, the cross-links are not formed by glutaraldehyde (GA).

In one aspect, described herein is a process for producing a cross-linked polymer film or a cross-linked polymer nanofiber, the process comprising: forming a polymer film or polymer nanofiber from a fluid stock, the fluid stock comprising a cross-linking agent and at least one polymer; and treating the polymer film or polymer nanofiber with a cross-linking catalyst, thereby cross-linking the polymer film or the polymer nanofiber.

In one aspect, described herein is a system for producing a cross-linked polymer nanofiber, the system comprising: an electrospinner; and a fluid stock comprising a polymer and a cross-linking agent.

In some embodiments, the fluid stock does not comprise a cross-linking catalyst. In some embodiments, the system further comprises a module suitable for contacting nanofibers with a cross-linking catalyst.

In one embodiment, described herein is a process for producing a stabilized nanofiber product, the process comprising: electrospinning a fluid stock to form a nanofiber, the fluid stock comprising (or produced by combining) a stabilizing agent and at least one polymer; and exposing (e.g., the surface of) nanofiber to a stabilizing catalyst (e.g., an acid vapor, such as an organic acid vapor), thereby producing the stabilized nanofiber product. In a specific embodiment, provided herein is a process for producing a stabilized nanofiber product, the process comprising: (a) electrospinning a fluid stock to form a nanofiber, the fluid stock comprising (or produced by combining) a stabilizing agent and at least one polymer; (b) thermally treating the nanofiber (e.g., at high temperature and under inert conditions to carbonize the polymer); and (c) exposing (e.g., the surface of) nanofiber to a stabilizing catalyst, thereby producing the stabilized nanofiber product.

In some embodiments, the stabilizing agent is a cross-linking agent, such as described herein. In certain embodiments, the stabilizing agent is an agent that is utilized to stabilize the nanofiber. In some embodiments, the stabilizing agent is a monomer (e.g., of a polymer described herein—that is polymerized after electrospinning to stabilize the nanofiber), sulfur or hydrogen sulfide (e.g., that is reacted after electrospinning or carbonization—such as to form a disulfide, or further polymerize to form a polysulfide), or a metal salt (e.g., to subsequently react with a monomer or sulfur—e.g., added as a stabilizing catalyst—and thereby stabilize the nanofiber). In some embodiments, the metal salt is a lithium salt, a sodium salt, or the like. In certain embodiments, the metal salt is lithium chloride, lithium nitrate, lithium acetate, sodium chloride, sodium nitrate, sodium acetate, or the like. In some embodiments, the stabilizing catalyst is polymerization initiator (e.g., radical initiator, such as AIBN, a peroxide, or the like; a cationic initiator (e.g., a metal salt); an anionic initiator (e.g., a metal salt); or the like), a monomer (e.g., whose polymerization is initiated by contact with the stabilizing agent), sulfur, hydrogen sulfide, or the like. In certain embodiments, when the stabilized nanofiber comprises a polymer matrix (e.g., wherein the polymer is not carbonized), the stabilization agent is a monomer or a crosslinking agent. In other embodiments, e.g., wherein the stabilized nanofiber comprises a carbon matrix (e.g., wherein the polymer is not carbonized), the stabilization agent is sulfur or a metal salt.

### BRIEF DESCRIPTION OF THE DRAWINGS

Certain aspects of the invention are set forth with particularity in the appended claims. A better understanding of the features and advantages of the present disclosure will be obtained by reference to the following detailed description that sets forth illustrative embodiments, in which the principles described herein are utilized, and the accompanying drawings of which:

FIG. 1 illustrates a schematic of the production of cross-linked PVA and its hybrid nanofibers via surface treatment.

FIG. 2 illustrates SEM images of PVA/SPI (75%/25%) hybrid nanofibers before and after crosslinking panel A—as spun, panel B—soaked in water after crosslinking with HCl, panel C—soaked in water after crosslinking with acetic acid).

FIG. 3 illustrates SEM images of PVA nanofibers as spun (panel A) and soaked in water after crosslinking with acetic acid (panel B) for a degree of hydrolysis of the PVA (DH) of 88%.

FIG. 4 illustrates SEM images of PVA nanofibers as spun (panel A) and soaked in water after crosslinking with acetic acid (panel B) for a degree of hydrolysis of the PVA (DH) of 99.7%.

FIG. 5 illustrates SEM images of PVA/SPI (75%/25%) nanofibers and demonstrates the stability of the product in water. Panel A illustrates an SEM of the as spun fiber; panel B illustrates as SEM of the stabilized fiber (treated with acetic acid for 1 minute) after being soaked in water; panel C illustrates as SEM of the stabilized fiber (treated with acetic acid for 3 minute) after being soaked in water; and panel D illustrates as SEM of the stabilized fiber (treated with acetic acid for 5 minute) after being soaked in water. As seen by the images, the water resistance of the nanofiber improves substantially with the crosslinking (i.e., as demonstrated by improved water resistance with increased crosslinking reaction times).

FIG. 6 illustrates an exemplary crosslinking mechanism, specifically for PVA with GA.

FIG. 7 illustrates an exemplary crosslinking mechanism, specifically for SPI with GA.

FIG. 8 illustrates an SEM image of nanofibers on a cellulose filter before filtration.

FIG. 9 illustrates an SEM image of nanofibers on a cellulose filter after filtration.

FIG. 10 illustrates a plot of filtration efficiency versus particle size for PVA nanofibers on a cellulose filter. The arrow illustrates the improved filtration efficiency, increasing from less than 10% to 70% with 2.4 g/m² coverage with stabilized polymer products (nanofibers) described herein.

FIG. 11 illustrates a plot of filtration efficiency versus particle size for SPI/PVA nanofibers on a cellulose filter. The arrows illustrate the further improvement (e.g., 10-15%) to synthetic polymer (PVA) fibers by the addition of natural polymers (soy proteins) in the stabilized products.

FIG. 12 illustrates SEM images of before (above) and after (below) crosslinking of PVA/SPI hybrid nanofibers by surface treatment for (a) 100% PVA, (b) PVA/SPI (75%/25%), (c) PVA/SPI (50%/50%), and (d) PVA/SPI (25%/75%).

FIG. 13 illustrates SEM images of gas-assisted electrospun PVA/SPI (75%/25%) hybrid nanofibers from 10 wt % aqueous solution of PVA/SPI.

FIG. 14 illustrates SEM images of gas-assisted electrospun PVA/SPI (75%/25%) hybrid nanofibers from 7 wt % aqueous solution of PVA/SPI.

### DETAILED DESCRIPTION OF THE INVENTION

Provided herein are stabilized products (e.g., cross-linked polymer products), including nanofibers comprising intra- and/or inter-nanofiber crosslinked polymers, and processes of preparing the same.

In one embodiment, described herein is a process for producing a stabilized product (e.g., a nanoproduct, such as a film or nanofiber), the process comprising: processing a fluid stock to form a polymer containing product (such as a film product or a fiber product), the fluid stock comprising (or produced by combining) a stabilizing agent (e.g., a cross-linking agent) and at least one polymer; and exposing (e.g., the surface of) the product to a stabilizing catalyst (e.g., an acid vapor, such as an organic acid vapor), thereby producing the stabilized product. In a specific embodiment, before or after stabilization, the polymer is thermally treated (e.g., at a temperature above 400° C. and under inert conditions, such as an argon, argon/hydrogen, or nitrogen atmosphere) to produce a carbon containing product (e.g., a film or fiber comprising a carbon matrix).

In one aspect, described herein is a process for producing a cross-linked polymer product, the process comprising: (a) forming a product from a fluid stock, the fluid stock comprising a cross-linking agent and at least one polymer that is water soluble; and (b) exposing the surface of the product to a cross-linking catalyst, thereby producing the cross-linked polymer product. In some embodiments, the cross-linked product is water-resistant. In some embodiments, the product is a nanofiber.

In some embodiments, the fluid stock comprises a crosslinking catalyst and the product is exposed to a crosslinking agent. For example, described herein is a process for producing a cross-linked polymer product, the process comprising: (a) forming a product from a fluid stock, the fluid stock comprising a cross-linking catalyst and at least one polymer that is water soluble; and (b) exposing the surface of the product to a cross-linking agent, thereby producing the cross-linked polymer product. In some embodiments, the cross-linked product is water-resistant. In some embodiments, the product is a nanofiber.

In one aspect, described herein is a fluid-resistant nanofiber, wherein the nanofiber: (a) comprises cross-linked polymer on the surface of the nanofiber, the cross-linked polymer being soluble in a fluid when not cross-linked; and (b) is resistant to dissolution or swelling in the fluid. In some embodiments, the fluid is water.

In one aspect, described herein is a filter comprising fluid-resistant cross-linked polymer nanofibers, wherein the polymer is soluble in the fluid in the absence of cross-linking. In some embodiments, the fluid is water. In some instances, the filter is capable of removing at least 70% of 300 nm diameter particles from a fluid stream when the nanofiber coverage is 1.0 g/m².

### Stabilized/Cross-Linked (Nanofiber) Products

Provided herein are cross-linked polymer products, including nanofibers comprising intra- and/or inter-nanofiber crosslinked polymers.

In one aspect, the nanofibers produced by any of the methods described herein are encompassed within the disclosure herein. For example, described herein are nanofibers produced by (a) forming a nanofiber from a fluid stock, the fluid stock comprising a cross-linking agent and at least one polymer that is water soluble; and (b) exposing the surface of the nanofiber to a cross-linking catalyst, thereby producing the cross-linked polymer nanofiber.

In one aspect, described herein is a fluid-resistant product (e.g., nanofiber), wherein the product (e.g., nanofiber): (a) comprises cross-linked polymer on the surface of the product (e.g., nanofiber), the cross-linked polymer being soluble in a fluid when not cross-linked; and (b) is resistant to dissolution or swelling in the fluid. In some embodiments, the fluid is water. In some embodiments, the fluid is an organic solvent (e.g., acetone, hexane, ethanol).

In some embodiments, the products (e.g., nanofibers) described herein are non-swollen. For example, the size and/or shape of the product (e.g., nanofiber) is substantially unchanged upon stabilization or cross-linking (i.e., non-swollen). In some embodiments, the diameter of the nanofibers after stabilization (e.g., crosslinking) is about 80%, about 90%, about 100%, about 110%, about 120%, about 130%, and the like of the diameter of the nanofiber before stabilization (e.g., crosslinking) In some embodiments, the diameter of the nanofibers after stabilization (e.g., crosslinking) is at most 80%, at most 90%, at most 100%, at most 110%, at most 120%, at most 130%, and the like of the diameter of the nanofiber before stabilization (e.g., crosslinking). In some embodiments, the diameter of the nanofibers after stabilization (e.g., crosslinking) is at least 80%, at least 90%, at least 100%, at least 110%, at least 120%, at least 130%, and the like of the diameter of the nanofiber before stabilization (e.g., crosslinking). In some embodiments, the diameter of the nanofibers after stabilization (e.g., crosslinking) is between 80% and 120%, between 90% and 110%, between 95% and 105%, and the like of the diameter of the nanofiber before stabilization (e.g., crosslinking).

In some embodiments, the surface of the nanofiber is stabilized (e.g., crosslinked). In some embodiments, the nanofiber further comprises fluid (e.g., water) soluble polymer away from the surface of the nanofiber. In some embodiments, the nanofiber comprises unstabilized (e.g., non-crosslinked polymer) away from the surface of the nanofiber. The stabilized component (e.g., crosslinked component) penetrates any suitable depth into the nanofiber. In some embodiments, about 0.1%, about 0.5%, about 1%, about 5%, about 10%, and the like of the outer volume (i.e., surface) of the nanofiber is stabilized (e.g., crosslinked)—or comprises stabilized component. In some embodiments, at least 0.1%, at least 0.5%, at least 1%, at least 5%, at least 10%, and the like of the outer volume (i.e., surface) of the nanofiber is stabilized (e.g., crosslinked)- or comprises stabilized component. In some embodiments, at most 0.1%, at most 0.5%, at most 1%, at most 5%, at most 10%, and the like of the outer volume (i.e., surface) of the nanofiber is stabilized (e.g., crosslinked), or comprises stabilized component. In some embodiments, about 99.9%, about 99.5%, about 99%, about 95%, about 90%, and the like of the inner volume (i.e., core) of the nanofiber is not stabilized (e.g., crosslinked) and/or is fluid soluble. In some embodiments, at least 99.9%, at least 99.5%, at least 99%, at least 95%, at least 90%, and the like of the inner volume (i.e., core) of the nanofiber is not stabilized (e.g., crosslinked) and/or is fluid soluble. In some embodiments, at most 99.9%, at most 99.5%, at most 99%, at most 95%, at most 90%, and the like of the inner volume (i.e., core) of the nanofiber is not stabilized (e.g., crosslinked) and/or is fluid soluble.

In some embodiments, the product (e.g., nanofiber) comprises any suitable polymer. In some embodiments, the polymer is any material which is soluble in water or weak alkaline solvents. In some embodiments, the nanofiber is biodegradable. In some embodiments, the nanofiber is not biodegradable.

In some embodiments, the nanofiber comprises protein. Without limitation, exemplary proteins include soy protein isolate (SPI), soy protein concentrate, soy flour, or any combination thereof. In some embodiments, the nanofiber comprises protein, polyvinyl alcohol (PVA), polyvinyl acetate (PVAc), polyethylene oxide (PEO), polyvinylpyrrolidone (PVP), or any combination thereof. In some embodiments, the nanofiber does not comprise both PVA and SPI.

In some embodiments, the polymers are bio-based, optionally comprising materials sourced from plants, animals, microbes and the like. In some instances, the polymer comprises proteins or starches including modifications thereof and combinations thereof. In some embodiments, the nanofiber described herein comprises protein and/or peptide, which is denatured in some embodiments. Examples of the protein include soy-based materials such as soy-protein concentrate (“SPC”), soy flours (“SF”), and/or soy-protein isolates (“SPI”). In some embodiments, the protein comprises whey, gluten, zein, albumin, and gelatin, among others. In some instances, the proteins are from any plant source or animal source. In some embodiments, the protein is a proteoglycan.

In some embodiments, the polymer is a water-soluble polymer. In other embodiments, the polymer is a water-insoluble polymer. In some embodiments, the polymer is a solvent-soluble polymer. In certain embodiments, the polymer is a thermoplastic. Generally, the polymer is capable of being electrospun or formed into a film. In some embodiments, the polymer is polyimide, nylon, polyaramide, polybenzimidazole, polyetherimide, polyacrylonitrile, polyethylene terphthalate (PET), polypropylene, polyethylene oxide (PEO), polyaniline, polyethylene naphthalate (PEN), polybutylene terephthalate (PBT), polystyrene, polyvinyl chloride (PVC), polyvinyl alcohol (PVA), polyvinylidene fluoride (PVDF), polyvinyl butylene, copolymers thereof, combinations thereof, or the like. Exemplary polymers suitable for use in the methods and products described herein include but are not limited to polyvinyl ether, polyvinyl pyrrolidone, polyglycolic acid, hydroxyethylcellulose (“HEC”), ethylcellulose, cellulose ethers, polyacrylic acid, polyisocyanate, and the like. In some embodiments, the polymer is starch, chitosan, xanthan, agar, guar gum, and the like.

In some instances, the product (e.g., nanofibers) are protein-based, optionally denatured proteins or peptides. In some embodiments, nanofibers described herein are substantially free of a toxic solvent. In some embodiments, nanofibers described herein are substantially free (e.g., less than 1% w/w, less than 0.5% w/w, less than 0.1% w/w, less than 0.01% w/w) of a solvent other than water or alcohol.

In some embodiments, the product (e.g., nanofiber) described herein comprises a polymer. The polymer is optionally biodegradable or non-biodegradable. The polymer is any suitable polymer. In some embodiments, the polymer is a water-soluble polymer (including, e.g., synthetic polymers) such as polyvinyl alcohol (PVA), polyvinyl acetate (PVAc), polyethylene oxide (PEO), polyvinylpyrrolidone (PVP), polyethylene glycol (PEG), or any combination thereof. In some embodiments, the nanofiber does not comprise both PVA and SPI. In other embodiments, the polymer is as described herein. In some embodiments, the product (e.g., nanofiber) comprises carbon (e.g., a continuous carbon matrix). In some instances, the carbon is from polymer that has been carbonized (e.g., and the product does not comprise polymer).

### Characteristics of the Products

Without limitation, the products (e.g., nanofibers) described herein and process for producing the products (e.g., nanofibers) described herein results in non-swollen products, high tensile strength products, thermally stable products, water stable products, moisture stable products, solvent stable products, chemically stable products, and/or the like.

In one aspect, the products (e.g., nanofibers) and process for producing products (e.g., nanofibers) described herein results in products (e.g., nanofibers) with a high tensile strength. In some embodiments, the tensile strength of the product (e.g., nanofiber) after cross-linking is at least the same as the tensile strength of the product (e.g., nanofiber) before cross-linking and/or in an identical product without cross-linking agent or cross-linking (as provided herein). In some embodiments, the tensile strength of the product (e.g., nanofiber) after cross-linking is about 80%, about 90%, about 100%, about 110%, about 120%, about 130%, and the like of the tensile strength of the product (e.g., nanofiber) before cross-linking (or otherwise similar product lacking cross-linking or cross-linking agent). In some embodiments, the tensile strength of the product (e.g., nanofiber) after cross-linking is at least 80%, at least 90%, at least 100%, at least 110%, at least 120%, at least 130%, and the like of the tensile strength of the product (e.g., nanofiber) before cross-linking (or otherwise similar product lacking cross-linking or cross-linking agent).

In one aspect, the products (e.g., nanofibers) and process for producing products (e.g., nanofibers) described herein results in nanofibers with a high thermal stability. In some embodiments, the thermal degradation temperature of the product (e.g., nanofiber) after crosslinking is at least as high as the thermal degradation temperature of the product (e.g., nanofiber) before crosslinking (or in an otherwise similar product lacking cross-linking or cross-linking agent). In some embodiments, the thermal degradation temperature of the product (e.g., nanofiber) after cross-linking is about 80%, about 90%, about 100%, about 110%, about 120%, about 130%, and the like of the thermal degradation temperature of the product (e.g., nanofiber) before cross-linking (or in an otherwise similar product lacking cross-linking or cross-linking agent). In some embodiments, the thermal degradation temperature of the product (e.g., nanofiber) after cross-linking is at least 80%, at least 90%, at least 100%, at least 110%, at least 120%, at least 130%, and the like of the thermal degradation temperature of the product (e.g., nanofiber) before cross-linking (or in an otherwise similar product lacking cross-linking or cross-linking agent). The thermal degradation temperature is any suitable temperature. In some embodiments the product (e.g., nanofibers) begin degrading at about 200° C., about 300° C., about 400° C., about 500° C., about 600° C., about 700° C., about 800° C., about 900° C., about 1,000° C., and the like (e.g., in air).

The nanofiber has any suitable diameter, including diameters greater than 1,000 nm (i.e. greater than 1 nm). In some embodiments, a given collection of nanofibers have nanofibers that have a distribution of fibers of various diameters. In some embodiments, a single nanofiber has a diameter that varies along its length. In some instances, fibers of a population or portions of a fiber accordingly exceed or fall short of the average diameter. In some embodiments, the nanofiber has on average a diameter of about 20 nm, about 30 nm, about 40 nm, about 50 nm, about 60 nm, about 70 nm, about 80 nm, about 90 nm, about 100 nm, about 130 nm, about 150 nm, about 200 nm, about 250 nm, about 300 nm, about 400 nm, about 500 nm, about 600 nm, about 700 nm, about 800 nm, about 900 nm, about 1,000 nm, about 1,500 nm, about 2,000 nm and the like. In some embodiments, the nanofiber has on average a diameter of at most 20 nm, at most 30 nm, at most 40 nm, at most 50 nm, at most 60 nm, at most 70 nm, at most 80 nm, at most 90 nm, at most 100 nm, at most 130 nm, at most 150 nm, at most 200 nm, at most 250 nm, at most 300 nm, at most 400 nm, at most 500 nm, at most 600 nm, at most 700 nm, at most 800 nm, at most 900 nm, at most 1,000 nm, at most 1,500 nm, at most 2,000 nm and the like. In some embodiments, the nanofiber has on average a diameter of at least 20 nm, at least 30 nm, at least 40 nm, at least 50 nm, at least 60 nm, at least 70 nm, at least 80 nm, at least 90 nm, at least 100 nm, at least 130 nm, at least 150 nm, at least 200 nm, at least 250 nm, at least 300 nm, at least 400 nm, at least 500 nm, at least 600 nm, at least 700 nm, at least 800 nm, at least 900 nm, at least 1,000 nm, at least 1,500 nm, at least 2,000 nm and the like. In yet other embodiments, the nanofiber has on average a diameter between about 50 nm and about 200 nm, between about 50 nm and about 150 nm, between about 100 nm and about 400 nm, between about 100 nm and about 200 nm, between about 500 nm and about 800 nm, between about 60 nm and about 900 nm, and the like.

### Forming Nanofibers or Films

In one aspect, described herein is a process for producing a stabilized product (e.g., cross-linked polymer product), the process comprising forming a product from a fluid stock. In some embodiments, the product is a nanofiber (e.g., a polymer containing nanofiber or a carbon containing nanofiber). In some embodiments, polymer containing nanofibers are produced from fluid stocks by electrospinning (and carbon containing nanofibers are produced by carbonizing polymer containing nanofibers prepared by electrospinning).

Any suitable method for electrospinning is used. For example, elevated temperature electrospinning is described in U.S. Pat. No. 7,326,043 filed on Oct. 18, 2004; U.S. patent application Ser. No. 13/036,441 filed on Feb. 28, 2011; and U.S. Pat. No. 7,901,610 filed on Jan. 10, 2008.

In some embodiments, the electrospinning step comprises co-axially electrospinning the fluid stock with a second fluid. Co-axial electrospinning is described in PCT Patent Application PCT/US11/24894 filed on Feb. 15, 2011.

In some embodiments, the second fluid is a gas (i.e., the electrospinning is gas assisted). In some embodiments, a gas is co-axially electrospun with the fluid stock (i.e., the electrospinning is gas assisted). Gas-assisted electrospinning is described in PCT Patent Application PCT/US11/24894 filed on Feb. 15, 2011. Briefly, gas-assisted electrospinning comprises expelling a stream of gas at high velocity along with the fluid stock (e.g., as a stream inside the fluid stock or surrounding the fluid stock), which can increase the through-put of an electrospinning process. In some embodiments, the fluid stock surrounds the gas stream. In some embodiments, the nanofibers comprise a hollow core (e.g., when electrospun with an inner gas stream).

In some embodiments, the nanofibers are porous. Without limitation, porous nanofibers have a high surface area. Methods for producing ordered porous nanofibers are described in U.S. Provisional Patent Application No. 61/599,541 filed on Feb. 16, 2012. As described therein, co-axially electrospinning a fluid stock comprising a block co-polymer surrounded by a coating, then annealing to allow the blocks of the block co-polymer to assembled ordered phase elements, followed by selective removal of at least one of the phases produces ordered porous nanofibers.

Without limitation, in various embodiments, nanofibers are produced from a fluid stock by electroblowing a fluid stock, centrifugal spinning a fluid stock, or any combination thereof. Exemplary methods of electroblowing are described in U.S. Pat. No. 7,582,247 and U.S. Patent Publication No. 2010/0059906 A1.

In some instances, the polymer product is a film. Suitable methods for forming a film from the fluid stock include without limitation, spin coating, spraying, deposition, or any combination thereof. For example, a film is deposited on a flat surface by placing a volume of the fluid stock near the center of the surface and rotating the surface at a sufficiently high rate to spread the volume of fluid stock over the surface by centrifugal force.

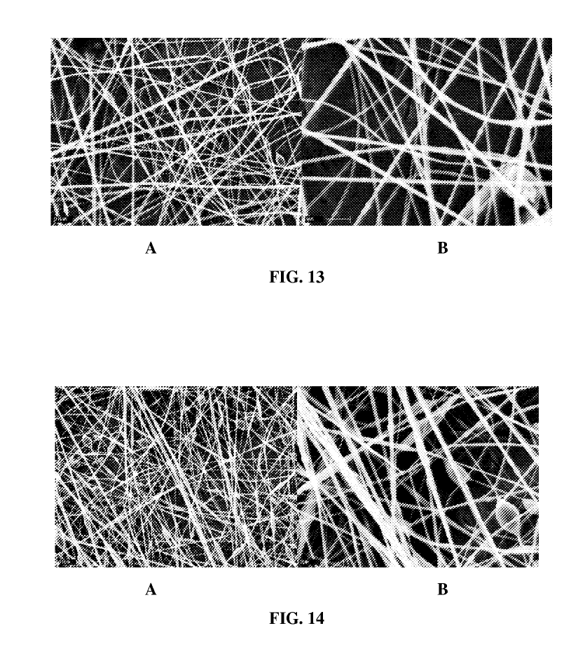

Exemplary hybrid nanofibers (PVA/SPI of 75%/25%) produced by a gas-assisted electrospinning process are shown (SEM image) in FIG. 13 (10% solution) and FIG. 14 (7% solution).

### Fluid Stock and Polymers

In one aspect, described herein is a process for producing a cross-linked polymer product, the process comprises forming a product from a fluid stock, the fluid stock comprising a cross-linking agent and at least one polymer. In some embodiments, the polymer is water soluble. In some embodiments, the product is a nanofiber. In some embodiments, the cross-linked product is water-resistant. In some embodiments, the fluid stock is aqueous.

The polymer is any suitable polymer. In some embodiments, the polymer is any material which is soluble in water or weak alkaline solvents. In some embodiments, the polymer is biodegradable. In some embodiments, the polymer is not biodegradable.

In some embodiments, the polymer comprises protein. Without limitation, exemplary proteins include soy protein isolate (SPI), soy protein concentrate, soy flour, or any combination thereof. In some embodiments, the polymer is protein, polyvinyl alcohol (PVA), polyvinyl acetate (PVAc), polyethylene oxide (PEO), polyvinylpyrrolidone (PVP), or any combination thereof. In some embodiments, the fluid stock does not comprise PVA. In some embodiments, the fluid stock does not comprise both PVA and SPI.

In some embodiments, the polymers are bio-based, optionally comprising materials sourced from plants, animals, microbes and the like. In some instances, the polymer comprises proteins or starches including modifications thereof and combinations thereof.

In some instances, the polymers are protein-based, optionally denatured proteins or peptides. By way of example, described herein are combinations of components that are mixed together to form a fluid stock that is electro-deposited (e.g., electro-spun) to form a plurality of nanofibers. In one embodiment, the fluid stock comprises one or more component solutions such as a protein-based solution and a carrier polymer solution. Component solutions are optionally aqueous-based solutions with water-soluble and/or water-processable components, thus eliminating the need for organic solvents and other chemicals. Other suitable solvents (e.g., non-toxic solvents), such as ethanol, are optionally utilized alone or in combination with water. In some embodiments, fibers and filters described herein are substantially free of a toxic solvent. In some embodiments, fibers and filters described herein are substantially free (e.g., less than 1% w/w, less than 0.5% w/w, less than 0.1% w/w, less than 0.01% w/w) of a solvent other than water or alcohol.

In some embodiments, the fiber or protein-based solution described herein comprises a protein and/or peptide component, which is denatured in some embodiments. In some embodiments, the viscosity of the deposition solution is suitable for formation of electro-spun fibers. Examples of the protein component include soy-based materials such as soy-protein concentrate (“SPC”), soy flours (“SF”), and/or soy-protein isolates (“SPI”). In some embodiments, the protein component comprises other proteins such as whey, gluten, zein, albumin, and gelatin, among others. In some instances, the proteins are from any plant source or animal source. In some embodiments, the protein component is a proteoglycan.

In some embodiments, the fiber or carrier polymer solution described herein comprises a carrier polymer. The carrier polymer is optionally biodegradable or non-biodegradable. The carrier polymer comprises any suitable polymer. This carrier polymer includes water-soluble polymers (including, e.g., synthetic polymers) such as polyvinyl alcohol (PVA) and/or other polymers that facilitate processing and/or production of a fiber (e.g., during electro-spinning) Such polymers also help to maintain the integrity of the protein-based component in some instances (e.g., during electro-spinning) Other examples of materials suitable for use as the carrier polymer include, but are not limited to, polyethylene oxide (PEO) and polyethylene glycol (PEG).

In some embodiments, the fiber or fluid stock described herein comprises a protein-based component and a carrier polymer (e.g., a water-soluble polymer) in a ratio of protein-based component to carrier polymer component of less than 99:1, or less than 98:2, or 0.001:1 to 99:1, or less than 1:1, or less than 2:1, or less than 3:1, or less than 4:1, or less than 5:1, or less than 10:1, or less than 20:1, or 0.01:1 to 1:1. In other embodiments, the ratio of carrier polymer component to protein-based component is less than 99:1, or less than 98:2, or 0.001:1 to 99:1, or less than 1:1, or less than 2:1, or less than 3:1, or less than 4:1, or less than 5:1, or less than 10:1, or less than 20:1, or 0.01:1 to 1:1.

In some embodiments, the fiber or fluid stock described herein also comprises supplemental components or a supplemental solution. In various embodiments, such supplemental components or solutions are used to modify aspects of the resulting fluid stock, fibers, and/or filter media. These modifications include, for example, improvements to stiffness and tensile strength of the fibers, improved filtering efficiency, and the like. The supplemental components/solutions comprise a variety of supplemental components such as, but not limited to fatty acids such as stearic acid, micro-scale and nano-scale particulates such as titanium dioxide (TiO₂) and nano-clay, nanocrystalline cellulose (NCC), cellulose nanocrystals (CNC), nanofibrillated cellulose (NFC), and carbon-based materials such as bio-char. Examples of nano-clay include halloysite nanotubes, montmorillonite or cloisite. In some embodiments, additives are included that modify one or more rheological properties of the fluid stock. Exemplary additives comprise, for example, additives for adjusting pH such as sodium hydroxide (NaOH), surfactants such as p-tertiary-octylphenoxy polyethyl alcohol and other additives for modifying surface tension and retarding gelation of, e.g., PVA when it is used as the carrier polymer.

In one embodiment, an exemplary supplemental component of the fluid stock is a biocidal agent (e.g., an anti fungal, anti-viral, and/or anti-bacterial agent). In specific embodiments, the biocidal agent is an antimicrobial nanoparticles such as silver, titanium, Sift, or gold nanoparticles. In another embodiment, the biocidal agent is sialic acid. Optionally, the biocidal agent is deposited on the filter medium rather than included in the fluid stock. Any suitable method for imparting lethality to the filter medium is encompassed by the present disclosure.

### Stabilizing/Cross-Linking Agents

In one aspect, described herein is a process for producing a stabilized product (e.g., cross-linked polymer product), the process comprises forming a product from a fluid stock, the fluid stock comprising at least one polymer and a stabilizing agent (e.g., cross-linking agent). A crosslinking agent is any compound, material, molecule, and the like capable of forming a crosslink (e.g., between polymer groups). In some embodiments, the crosslink is formed in the polymer comprising the product. In some embodiments, the crosslink is formed on the surface of the product. In some embodiments, the product is a nanofiber. In some instances, the crosslinks are formed between nanofibers. In some embodiments, the crosslinks make the product water resistant.

In some embodiments, any suitable cross-linking agent is used, such as, by way of non-limiting example, glutaraldehyde (GA), glyoxal, polyacetal, bis-β-hydroxyethyl sulfone, propylene glycol diglycidyl ether, 4,5-dihydroxy-1,3-dimethyleneurea and 4,5-dihydroxy-1,3-bis-(β-hydroxyethyl) ethyleneurea, dimethyl suberimidate, bissulfosuccinimidyl suberate (BS3), formaldehyde, carbodiimide, beeswax, hexamethylphosphoramide, or any combination thereof.

In some embodiments, the cross-linking agent cross-links protein. In some embodiments, the activity of the cross-linking agent is controlled by pH.

In some embodiments, the cross-linking agent is not glutaraldehyde (GA).

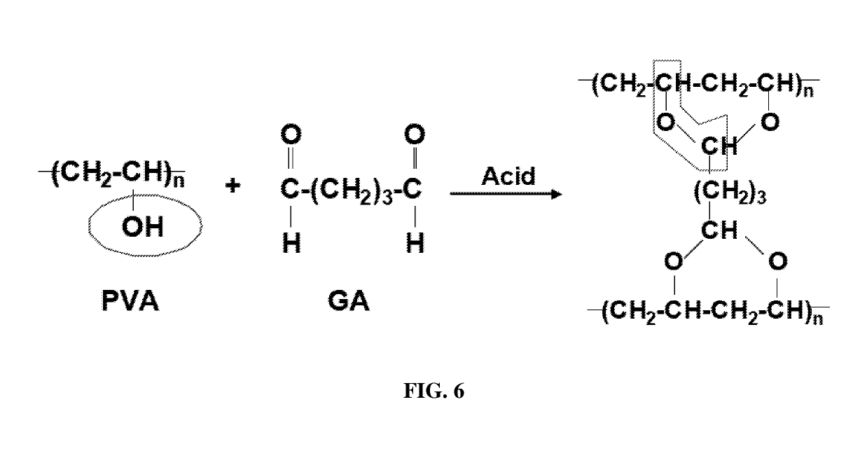

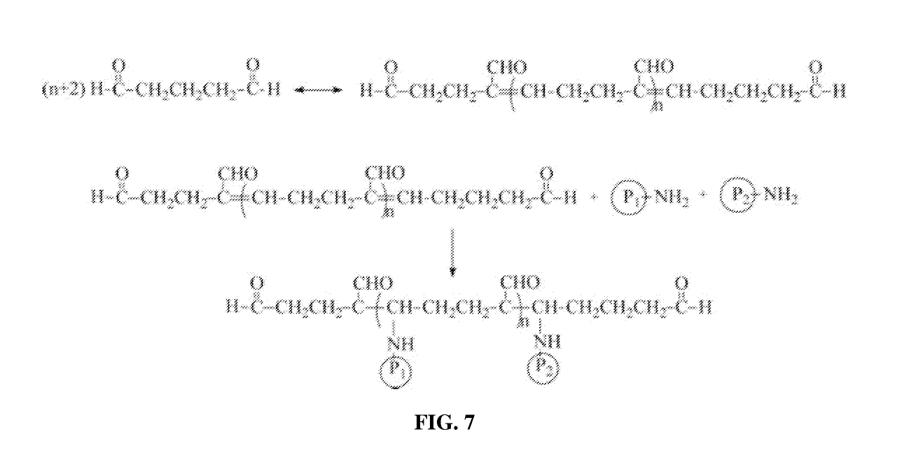

The stabilizing agent (e.g., crosslinking agent) comprises any suitable proportion of the fluid stock. In some embodiments, the fluid stock comprises about 0.01 wt %, about 0.05 wt %, about 0.1 wt %, about 0.5 wt %, about 1 wt %, about 5 wt %, about 10 wt %, or the like stabilizing (e.g., crosslinking) agent. In some embodiments, the fluid stock comprises at least 0.01 wt %, at least 0.05 wt %, at least 0.1%, at least 0.5 wt %, at least 1 wt %, at least 5 wt %, at least 10 wt %, at least 25 wt %, at least 50 wt %, or the like stabilizing (e.g., crosslinking) agent. In some embodiments, the fluid stock comprises at most 0.01 wt %, at most 0.05 wt %, at most 0.1 wt %, at most 0.5 wt %, at most 1 wt %, at most 5 wt %, at most 10 wt %, or the like stabilizing (e.g., crosslinking) agent. In some embodiments, the fluid stock comprises an amount of stabilizing (e.g., crosslinking) agent suitable for imparting water resistance to the product (e.g., nanofiber). FIG. 6 shows an exemplary putative crosslinking mechanism for PVA with GA. FIG. 7 shows an exemplary putative crosslinking mechanism for SPI with GA.

In some embodiments, stabilizing agent is a monomer (e.g., that polymerizes upon exposure to an initiator—as a stabilization catalyst), sulfur and/or hydrogen sulfide (e.g., that “polymerizes” upon exposure to an initiator—as a stabilization catalyst), a metal salt (e.g., that reacts with and polymerizes upon exposure to a monomer, sulfur, or hydrogen sulfide—as a stabilization catalyst), or a combination thereof. In specific embodiments, the product is a carbon containing product prepared by carbonizing a polymer containing product and the stabilizing agent is sulfur, hydrogen sulfide, and/or metal salt.

### Stabilizing/Cross-Linking Catalysts (e.g., Acids)

In one aspect, the method comprises exposing the surface of the product to a stabilizing (e.g., cross-linking) catalyst, thereby producing the stabilized (e.g., cross-linked polymer) product. In some embodiments, the cross-links are formed on the surface of the polymer film or the polymer nanofiber. In some embodiments, the cross-linked nanofiber further comprises non-crosslinked polymer away from the surface of the nanofiber. In some embodiments, intra-fiber cross-links are formed, inter-fiber cross-links are formed, or any combination thereof. In some embodiments, cross-links comprise covalent bonds, ionic bonds, or any combination thereof. In specific instances, the cross-links comprise a residue of the cross-linking agent (examples of which is illustrated in FIGS. 6 and 7).

In some instances, the stabilizing (e.g., crosslinking) catalyst is any compound, material, molecule, and the like capable of initiating and/or accelerating the formation of crosslinks (e.g., by the crosslinking agent). In some embodiments, the stabilizing (e.g., cross-linking) catalyst comprises acid. Any suitable acid is used. In some embodiments, the catalyst comprises citric acid, acetic acid, hydrofluoric acid, nitric acid, formic acid, carbonic acid, phosphoric acid, sulfuric acid, oxalic acid, or any combination thereof.

Any acids with a suitable pKa is optionally utilized. In some embodiments, the acid is a weak acid. In some embodiments, the acid is a strong acid. In some embodiments, the acid has a pKa of about −3, about −2, about −1, about 0.5, about 1, about 2, about 3, about 4, about 6, about 8, about 10, or the like. In some embodiments, the acid has a pKa of at least −3, at least −2, at least −1, at least 0.5, at least 1, at least 2, at least 3, at least 4, at least 6, at least 8, at least 10, or the like. In some embodiments, the acid has a pKa of at most −3, at most −2, at most −1, at most 0.5, at most 1, at most 2, at most 3, at most 4, at most 6, at most 8, at most 10, or the like.

In some embodiments, the stabilizing (e.g., cross-linking) catalyst comprises an acidic solution. In some embodiments, the cross-linking catalyst comprises acid vapor.

The concentration of the catalyst (e.g., acid in the solution or in the vapor) is any suitable concentration. In some embodiments, the catalyst comprises about 0.5%, about 1%, about 5%, about 10%, about 20%, about 30%, or the like by mass. In some embodiments, the catalyst comprises at least 0.5%, at least 1%, at least 5%, at least 10%, at least 20%, at least 30%, or the like by mass. In some embodiments, the catalyst comprises at most 0.5%, at most 1%, at most 5%, at most 10%, at most 20%, at most 30%, or the like by mass. In some embodiments, the concentration of the catalyst is sufficient to form crosslinks.

The formed polymer product (e.g., nanofiber or film) is exposed to (e.g., treated with, contacted with, or the like) with the stabilizing (e.g., crosslinking) catalyst for any suitable amount of time. In some embodiments, the product is exposed to the catalyst for about 1 second, about 10 seconds, about 1 minute, about 10 minutes, about 30 minutes, about 1 hour, about 2 hours, about 10 hours, or the like. In some embodiments, the product is exposed to the catalyst for at least 1 second, at least 10 seconds, at least 1 minute, at least 10 minutes, at least 30 minutes, at least 1 hour, at least 2 hours, at least 10 hours, or the like. In some embodiments, the product is exposed to the catalyst for at most 1 second, at most 10 seconds, at most 1 minute, at most 10 minutes, at most 30 minutes, at most 1 hour, at most 2 hours, at most 10 hours, or the like. In some embodiments, the product (e.g., nanofiber) is treated with acid vapor for between about 1 minute and 10 minutes. In some embodiments, the product is contacted with the catalyst for an amount of time sufficient to form crosslinks or otherwise stabilize the product.

In some aspects, the amount of stabilization, crosslinking, and/or the level of water resistance is controllable by the process described herein. In some embodiments, the product (e.g., nanofiber) is treated with stabilizing agent (e.g., acid vapor) for a time sufficient to achieve the desired amount of stabilization and/or cross-linking. In some embodiments, a nanofiber is treated with acid vapor having a concentration sufficient to achieve the desired amount of stabilization (e.g., depth of stabilized component penetrating into the product) and/or cross-linking (e.g., depth of cross-linked component penetrating into the product).

In some embodiments, stabilizing catalyst is an initiator (e.g., a radical polymerization initiator, such as a peroxide or AIBN, a cation polymerization initator, an anion polymerization initiator, or the like); a monomer (e.g., reacting with an initiator in the product); sulfur or hydrogen sulfide (e.g., reacting with a metal salt, metal cations, or anions in the product). In specific embodiments, the product is a carbon containing product prepared by carbonizing a polymer containing product and the stabilizing catalyst is sulfur, hydrogen sulfide, and/or metal salt.

### Fluid-Resistant Filters

Described herein is a filter comprising fluid-resistant (e.g., water resistant) cross-linked polymer nanofibers, wherein the polymer is soluble in the fluid (e.g., water) in the absence of cross-linking. In some embodiments, the surface of the nanofibers are cross-linked. In some embodiments, the filter further comprises fluid soluble polymer away from the surface of the nanofiber. Also described herein are filters comprising any of the nanofibers described herein, produced by the methods described herein, or capable of being produced by the methods described herein.

In some embodiments, the filters described herein are capable of filtering water and/or aqueous solutions. In some embodiments, the filters described herein are capable of filtering fluids comprising water vapor (e.g., humid gases such as air). The humidity is any suitable value. In some instances, the humidity is about 10%, about 20%, about 30%, about 40%, about 50%, about 60%, about 70%, about 80%, about 90%, about 100%, and the like. In some instances, the humidity is at least 10%, at least 20%, at least 30%, at least 40%, at least 50%, at least 60%, at least 70%, at least 80%, at least 90%, at least 100%, and the like. In some instances, the humidity is at most 10%, at most 20%, at most 30%, at most 40%, at most 50%, at most 60%, at most 70%, at most 80%, at most 90%, at most 100%, and the like. In one aspect, the filter does not dissolve, degrade, melt, deform, swell, or clog in the presence of water and/or water vapor.

In some embodiments, the nanofibers described herein are deposited randomly on a substrate. The nanofibers comprise a plurality of pores through which fluids (e.g., air) pass through the filter. In some instances, the fiber network is characterized by the density of these pores, the size of these pores, as well as by the distribution of the pore sizes. In some embodiments, the filter is biodegradable.

In some embodiments, the filters described herein meet the HEPA standard, wherein they capture at least 99.97% of particles having a diameter of at least 0.3 μm. In some embodiments, the filters described herein meet the ULPA standard, wherein they capture at least 99.999% of particles having a diameter of at least 0.12 μm. In some embodiments, the filter is capable of removing at least 70% of 300 nm diameter particles from a fluid stream when the nanofiber coverage is 1.0 g/m².

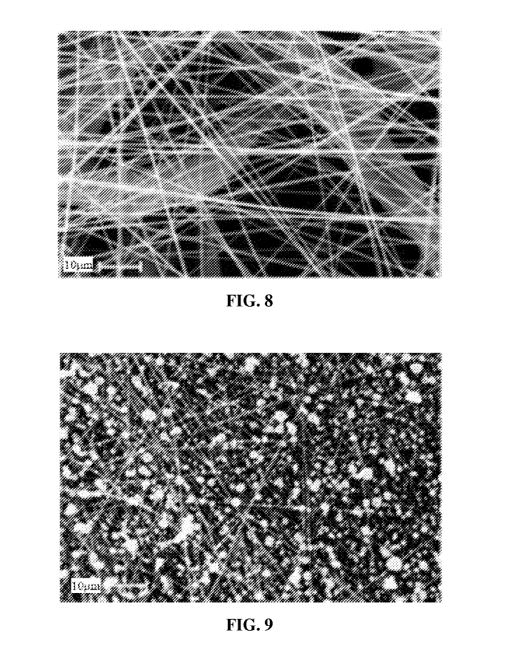

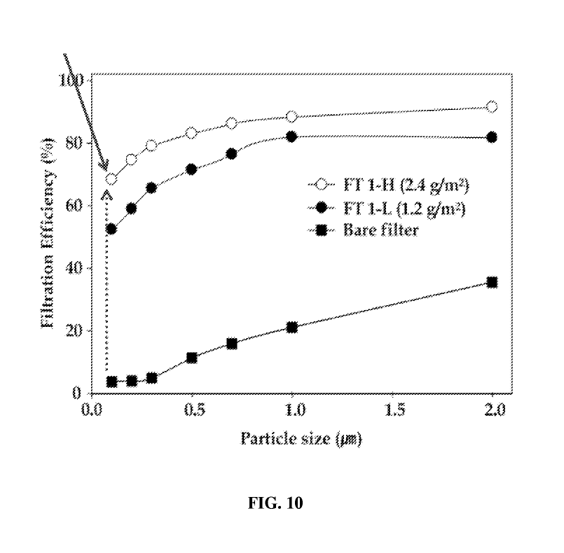

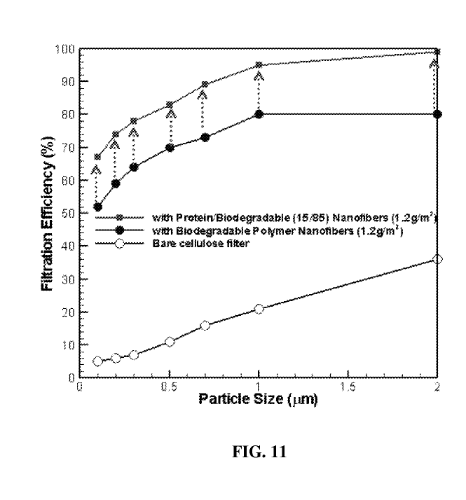

In some embodiments, the filters described herein are used to filter a fluid. For example, FIG. 8 shows a SEM image of nanofibers on a cellulose filter before filtration and FIG. 9 shows a SEM image of nanofibers after filtration. In this example, as seen in FIG. 10 (a plot of filtration efficiency versus particle size for PVA nanofibers on a cellulose filter), the filtration efficiency for 100 nm particles increases from less than 10% to 70% with 2.4 g/m² nanofiber coverage. As seen in FIG. 11 (a plot of filtration efficiency versus particle size for SPI/PVA nanofibers on a cellulose filter), filtration efficiency further increases by 15 to 20% with 15% addition of soy proteins to the nanofibers.

In some embodiments, the filters described herein are flexible, which allows the filter medium to be rolled or folded into a cartridge. In another aspect, the filter medium is thin and/or has a low mass per unit area which allows a relatively large area of filtration medium to be rolled or folded into a filtration cartridge.

In some embodiments, the filtration system described herein reduces the amount of energy needed to move a fluid through the filter and/or maintains a low pressure drop across the filter. The pressure drop across the filter is any suitable value. In some embodiments, the pressure drop is about 20 Pa, about 50 Pa, about 100 Pa, about 200 Pa, about 300 Pa, about 500 Pa, and the like. In some embodiments, the pressure drop is at most about 20 Pa, at most about 50 Pa, at most about 100 Pa, at most about 200 Pa, at most about 300 Pa, at most about 500 Pa, and the like. In some embodiments, the pressure drop is maintained within an operational range. For example, the pressure drop across the filter is between about 50 Pa and about 200 Pa, between about 100 Pa and about 300 Pa, between about 200 Pa and about 500 Pa, between about 20 Pa and about 500 Pa, and the like in some embodiments.

In some instances, the fiber network is characterized by the weight coverage of the fibers disposed on the substrate. In certain applications, it is beneficial to have a thin and/or light weight filter medium so that a larger area of the medium can be contained in a filter cartridge of a given size. By way of example, but not limitation, the weight coverage of fibers in the filter media is any suitable value including from about 0.2 g/m² to about 10 g/m². In some embodiments, the filter medium has a density of about 0.05 g/m², about 0.1 g/m², about 0.2 g/m², about 0.5 g/m², about 1.0 g/m², about 2 g/m², about 5 g/m², about 10 g/m², about 20 g/m², about 50 g/m², about 100 g/m², and the like. In other embodiments, the filter medium has a density of at least about 0.05 g/m², at least about 0.1 g/m², at least about 0.2 g/m², at least about 0.5 g/m², at least about 1.0 g/m², at least about 2 g/m², at least about 5 g/m², at least about 10 g/m², at least about 20 g/m², at least about 50 g/m², at least about 100 g/m², and the like. In other embodiments, the filter medium has a density of at least about 0.05 g/m², at most about 0.1 g/m², at most about 0.2 g/m², at most about 0.5 g/m², at most about 1.0 g/m², at most about 2 g/m², at most about 5 g/m², at most about 10 g/m², at most about 20 g/m², at most about 50 g/m², at most about 100 g/m², and the like.

In some embodiments, the nanofiber based filters described herein are capable of capturing and/or filtering particles that are as small as about 0.1 μm. The filters have any suitable pore size, such as an average pore diameter of about 20 nm, about 50 nm, about 100 nm, about 120 nm, about 200 nm, about 300 nm, about 500 nm, about 1 μm, about 2 μm, about 5 μm, about 10 μm, about 20 μm, and the like. In another embodiment, the average pore diameter is at most about 20 nm, at most about 50 nm, at most about 100 nm, at most about 120 nm, at most about 200 nm, at most about 300 nm, at most about 500 nm, at most about 1 μm, at most about 2 μm, at most about 5 μm, at most about 10 μm, about at most 20 μm, and the like.

The pore size is measured or estimated by any suitable means, such as any suitable method of microscopy. Another way to estimate pore size is to challenge the filter medium to a stream of particles of a known diameter(s) and determine what size particles are retained on the filter. For example, if 100 nm particles are retained on the filter, it can be estimated that the average pore size is less than about 100 nm.

In some embodiments, the filters described herein have a distribution of pore sizes. In some embodiments, the standard deviation of pore diameters is about 1%, about 5%, about 10%, about 15%, about 20%, about 25%, about 50%, and the like of the average pore diameter. In other embodiments, the standard deviation of pore diameters is at least about 1%, at least about 5%, at least about 10%, at least about 15%, at least about 20%, at least about 25%, at least about 50%, and the like of the average pore diameter. In other embodiments, the standard deviation of pore diameters is at most about 1%, at most about 5%, at most about 10%, at most about 15%, at most about 20%, at most about 25%, at most about 50%, and the like of the average pore diameter. In yet other embodiments, the standard deviation of pore diameters between about 1% and 10%, between about 5% and 20%, between about 10% and 50%, and the like of the average pore diameter.

### Systems for Producing a Stabilized Products (e.g., Cross-Linked Polymer Nanofibers)

In one aspect, described herein is a system for producing a stabilized product (e.g., a cross-linked polymer nanofiber), the system comprising (a) an electrospinner; and (b) a fluid stock comprising a polymer and a stabilizing (e.g., cross-linking) agent.

In some embodiments, the fluid stock does not comprise a stabilizing (e.g., cross-linking) catalyst. In other words, in some embodiments, the stabilizing agent present in the fluid stock does not does not stabilize the product in the absence of exposure to an additional agent (i.e., a stabilizing agent—chemical treatment of the product). In yet other embodiments, the stabilizing agent provides stability to the product upon exposure to thermal treatment.

In some embodiments, the system further comprises a module suitable for contacting nanofibers with a cross-linking catalyst (e.g., an acid vapor).

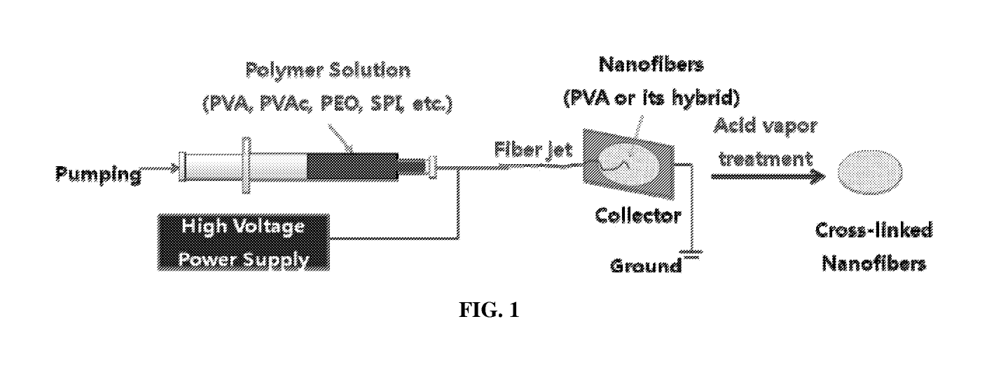

FIG. 1 illustrates an exemplary system or process described herein. In some embodiments, an electrospinning apparatus is provided, such as a syringe system with a nozzle illustrated in FIG. 1. In general instances, a polymer fluid stock, such as a polymer composition comprising PVA, PVAc, PEO, SPI, or other polymer described herein, is expelled from the nozzle of an electrospinning apparatus to form a droplet, whereupon high voltage is applied to the droplet, overcoming the surface tension and causing a jet to form; whipping of the jet then causes formation of a nanofiber product. Typically, the nanofibers are collected on a grounded collector. In certain embodiments, such nanofibers comprise a polymer and a cross-linking agent, e.g., as described and prepared according to the disclosures provided herein. In some embodiments, following collection, the nanofiber products are treated with a cross-linking catalyst (such as acid vapor) to form stabilized product (e.g., cross-linked—including, e.g., cross-linked on the surface—polymer nanofiber products). In certain specific embodiments, prior to stabilization of the product, the polymer of the nanofibers is carbonized (e.g., at elevated temperatures, such as 400 C to 2000 C, and optionally under inert conditions, such as in an argon, argon and hydrogen, or nitrogen atmosphere). In other embodiments, carbonization of the polymer is optionally performed after stabilization of the product. As specifically illustrated in FIG. 1, an exemplary embodiment includes a system wherein, a fluid stock comprising a polymer (e.g., PVA, PVAc, PEO, SPI) is expelled from a spinneret (i.e., nozzle) and accelerates a fiber jet toward a collector. In some embodiments, there is a voltage difference between the electrospinner (e.g., gas assisted electrospinner) and the collector. The nanofibers are treated with acid vapor to crosslink the surface of the nanofiber and render the nanofiber water-resistant.

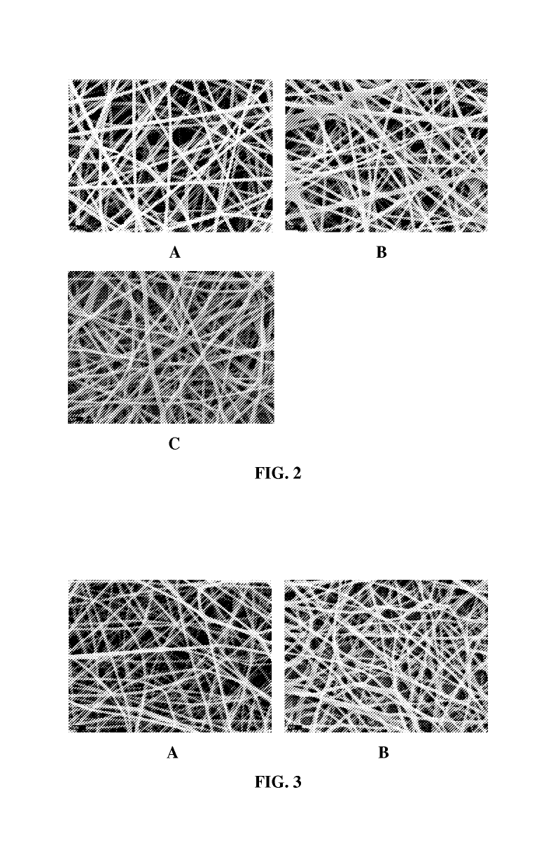

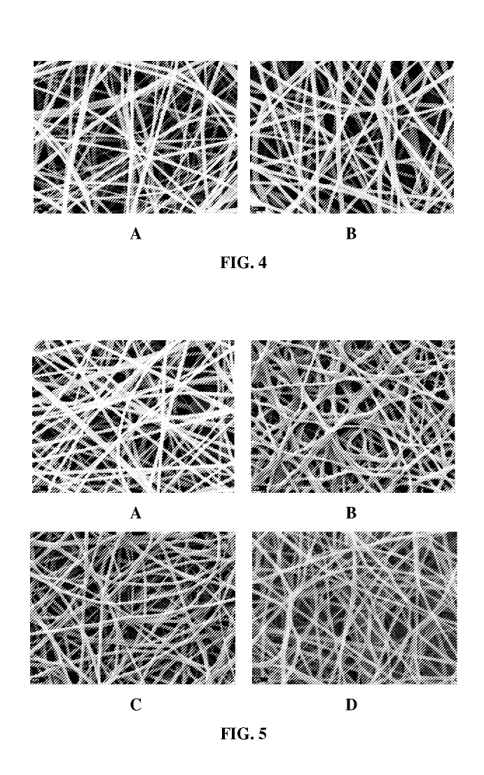

Exemplary SEM images of cross-linked nanofibers using different acids are shown in FIG. 2. Moreover, FIG. 2 illustrates the decreased swelling of stabilized/crosslinked nanofibers resulting from the less harsh acid vapor treatments than the harsh hydrogen chloride soaking treatment. As seen here, the morphology of the fibers is similar before and after crosslinking. The morphology is also unchanged after soaking the nanofibers in water with HCl catalyzed crosslinks (middle) and acetic acid catalyzed crosslinks (right). FIG. 3 and FIG. 4 show SEM images of 100% PVA nanofibers as spun (left) and soaked in water after acetic acid catalyzed crosslinking (right). The degree of hydrolysis (DH) of PVA is 88% in FIG. 3 and 99.7% in FIG. 4.

FIG. 5 shows SEM images of PVA/SPI (75%/25%) nanofibers before and after crosslinking (left to right—as spun fiber soaked in water after treatment with acetic acid for 0 minute, 1 minute, 3 minutes, and 5 minutes). As seen here, the nanofibers are water-resistant. In this example, the nanofibers do not swell, deform, or dissolve in the presence of water. For example, even though soy protein isolate (SPI) and polyvinyl alcohol (PVA) are water soluble and biodegradable materials.

### CERTAIN DEFINITIONS

The articles “a”, “an” and “the” are non-limiting. For example, “the method” includes the broadest definition of the meaning of the phrase, which can be more than one method.

### EXAMPLES

### Example 1

### Preparing a Fluid Stock

In a composition, 1 gram of polymer (e.g., polyvinyl alcohol (PVA)) is dissolved in 10 ml of de-ionized water. The polymer solution is heated to a temperature of 95° C. and stirred for 2 hours. Crosslinking agent (e.g., glutaraldehyde) is added in a suitable amount (e.g., 0.01 wt % to 5 wt %). The mixture is stirred for 2 hours to create a fluid stock.

### Example 2

### Preparing a Fluid Stock

In a composition, 1 gram of polymer (e.g., polyacrylonitrile (PAN)) is dissolved in 10 ml of dimethylformamide (DMF). The polymer solution is heated to a temperature of 95° C. and stirred for 2 hours. Crosslinking agent is added in a suitable amount (e.g., 0.01 wt % to 5 wt %). The mixture is stirred for 2 hours to create a fluid stock.

### Example 3

### Preparing a Fluid Stock

In a composition, 1 gram of polymer (e.g., polyvinyl alcohol (PVA) or a mixture of PVA and SPI) is dissolved in 10 ml of de-ionized water. The polymer solution is heated to a temperature of 95° C. and stirred for 2 hours. Crosslinking agent (e.g., glutaraldehyde) is added in a suitable amount (e.g., 0.1 wt % to 10 wt %). The mixture is stirred for 2 hours to create a fluid stock.

### Example 4

### Electrospinning a Fluid Stock

The fluid stock of any one of Examples 1-3 is electrospun (e.g., by a co-axial gas-assisted technique). The overall process and apparatus is depicted in FIG. 1. The fluid stock is loaded into a syringe pump connected to a needle apparatus. The distance between the nozzle and the collection plate is a suitable distance (e.g., 8-25 cm) and the fluid stock is spun at a suitable rate (e.g., 0.1 ml/min) A suitable charge is maintained at the collector (e.g., of +10-+20 kV).

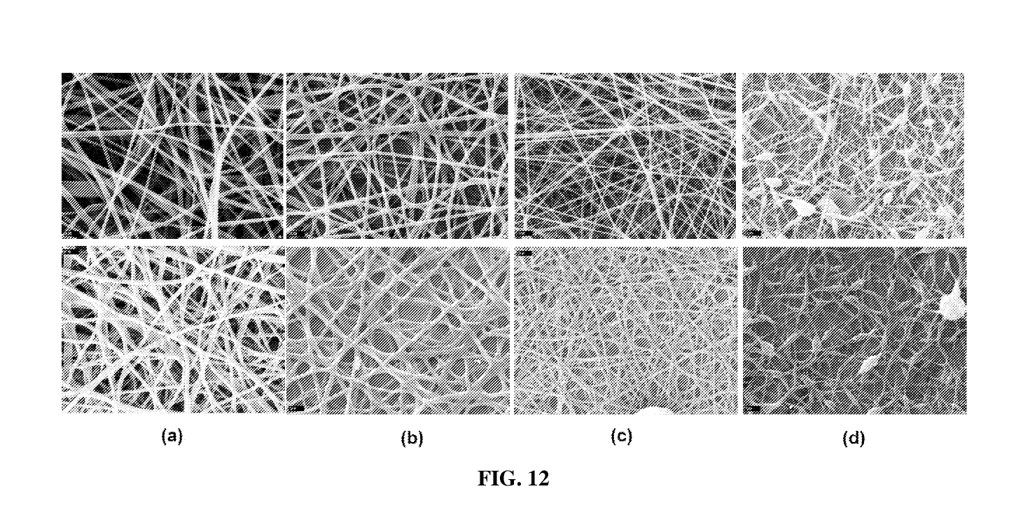

FIG. 2 (panel A) illustrates an SEM image of a nanofiber product prepared by such techniques and having been prepared from a fluid stock comprising polymer is a PVA/SPI weight ratio of 3:1. FIG. 3 (panel A) and FIG. 4 (panel A) illustrate SEM images of nanofiber products prepared by such techniques and having been prepared from a fluid stock comprising polymer is a PVA (prepared from 88% hydrolyzed and 99.7% hydrolyzed PVA, respectively). FIG. 12 illustrates SEM images of (top row) (a) 100% PVA, (b) PVA/SPI (75%/25%), (c) PVA/SPI (50%/50%), and (d) PVA/SPI (25%/75%) fibers prepared according to such processes.

FIG. 13 illustrates SEM images of gas-assisted electrospun PVA/SPI (75%/25%) hybrid nanofibers from 10 wt % aqueous solution of PVA/SPI. FIG. 14 illustrates SEM images of gas-assisted electrospun PVA/SPI (75%/25%) hybrid nanofibers from 7 wt % aqueous solution of PVA/SPI.

### Example 5

### Stabilization of Nanofibers

Polymer products, e.g., of Example 4, are exposed to catalyst (e.g., acid vapor) for a time sufficient to promote stabilization (e.g., improved water resistance) of the product. Polymer products are exposed to the catalyst for any suitable time to achieve desired stabilization levels (e.g., 1 minute to 1 hour).

FIG. 12 illustrates SEM images of PVA/SPI hybrid nanofibers after surface treatment (bottom row) for (a) 100% PVA, (b) PVA/SPI (75%/25%), (c) PVA/SPI (50%/50%), and (d) PVA/SPI (25%/75%).

FIG. 5 illustrates panel A illustrates an SEM of the as spun PVA/SPI (75%/25%) fiber; panel B illustrates as SEM of the stabilized fiber (treated with acetic acid for 1 minute) after being soaked in water; panel C illustrates as SEM of the stabilized fiber (treated with acetic acid for 3 minute) after being soaked in water; and panel D illustrates as SEM of the stabilized fiber (treated with acetic acid for 5 minute) after being soaked in water. As seen by the images, the water resitance of the nanofiber improves substantially with the crosslinking (i.e., as demonstrated by improved water resistance with increased crosslinking reaction times).

### Example 6

### Filter Products

Nanofiber polymer products of Example 5 are deposited on cellulose filter stock. FIG. 8 shows a SEM image of nanofibers on a cellulose filter before filtration and FIG. 9 shows a SEM image of nanofibers after filtration. FIG. 10 illustrates a plot of filtration efficiency versus particle size for PVA nanofibers on a cellulose filter, demonstrating that the filtration efficiency for 100 nm particles increases from less than 10% to 70% with 2.4 g/m² nanofiber coverage. FIG. 11 illustrates a plot of filtration efficiency versus particle size for SPI/PVA nanofibers on a cellulose filter, demonstrating that filtration efficiency further increases by 15 to 20% with 15% addition of soy proteins to the nanofibers.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A process for producing a water-resistant polymer nanofiber, the process comprising:
a. forming a polymer nanofiber from a fluid stock, the fluid stock comprising a cross-linking agent and at least one polymer that is water soluble; and
b. exposing the surface of the polymer nanofiber to a cross-linking catalyst, wherein the exposure results in the production of the water-resistant polymer nanofiber.

2. (canceled)

3. The process of claim 1, wherein the process further comprises forming the polymer nanofiber by one of electrospinning, electroblowing, centrifugal spinning, or any combination thereof.

4. The process of claim 1, wherein a gas is co-axially electrospun with the fluid stock.

5. The process of claim 1, wherein the fluid stock is aqueous.

6. The process of claim 1, wherein the polymer is one of protein, PVA, PVAc, PEO, PVP, or any combination thereof.

7. The process of claim 1, wherein the polymer comprises protein, the protein being one of soy protein isolate (SPI), soy protein concentrate, soy flour, or any combination thereof.

8. The process of claim 1, wherein the cross-linking agent is one of glutaraldehyde (GA), glyoxal, polyacetal, bis-β-hydroxyethyl sulfone, propylene glycol diglycidyl ether, 4,5-dihydroxy-1,3-dimethyleneurea and 4,5-dihydroxy-1,3-bis-(β-hydroxyethyl)ethyleneurea, dimethyl suberimidate, bissulfosuccinimidyl suberate (BS3), formaldehyde, carbodiimide, beeswax, hexamethylphosphoramide, or any combination thereof.

9. (canceled)

10. The process of claim 1, wherein the cross-linking catalyst comprises an acid.

11. (canceled)

12. The process of claim 1, wherein the catalyst comprises one of citric acid, acetic acid, hydrofluoric acid, nitric acid, formic acid, carbonic acid, phosphoric acid, sulfuric acid, oxalic acid, or any combination thereof.

13. (canceled)

14. (canceled)

15. The process of claim 1, wherein the tensile strength of the nanofiber after cross-linking is at least the same as the tensile strength of the nanofiber before cross-linking.

16. The process of claim 1, wherein the thermal degradation temperature of the nanofiber after cross-linking is at least as high as the thermal degradation temperature of the nanofiber before cross-linking.

17. A filter comprising fluid-resistant cross-linked polymer nanofibers, wherein the polymer is soluble in the fluid in the absence of cross-linking.

18. The filter of claim 17, wherein the fluid is water.

19. (canceled)

20. (canceled)

21. (canceled)

22. The filter of claim 17, wherein the filter is capable of removing at least 70% of 300 nm diameter particles from a fluid stream when the nanofiber coverage is 1.0 g/m².

23. (canceled)

24. (canceled)

25. (canceled)

26. (canceled)

27. (canceled)

28. (canceled)

29. A system for producing a stabilized polymer nanofiber, the system comprising:
a. an electrospinner; and
b. a fluid stock comprising a polymer and a stabilizing agent.

30. The system of claim 29, wherein the fluid stock does not comprise a stabilizing catalyst.

31. The system of claim 29, further comprising a module suitable for contacting nanofibers with a stabilizing catalyst.

32. A process for producing a stabilized nanofiber product, the process comprising:
a. electrospinning a fluid stock to form a nanofiber, the fluid stock comprising a stabilizing agent and at least one polymer; and
b. exposing the nanofiber to a stabilizing catalyst, thereby producing the stabilized nanofiber product.

33. (canceled)
